(19) United States
(12) Patent Application Publication
(10) Pub. No.: US 2005/0109425 A1
(43) Pub. Date: May 26, 2005

(54) Worktable elevating device for a planer

(76) Inventor: Bor Yann Chuang, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/716,492

(22) Filed: Nov. 20, 2003

(51) Int. Cl. B27C 1/00

(52) U.S. Cl. 144/117.1; 144/129; 144/130

(57) ABSTRACT

A worktable-elevating device for a planer is assembled on a worktable, including a base body provided with an input gear unit, two output gear units; a control rod, two elastic compressing units, and a worm holder. The input gear unit is driven by a motor installed on the worktable to rotate and actuate the two output gear units to rotate reversely. The control rod is pulled upward or downward to make the worm holder mesh with one of the two output gear units. As the worm holder and the planing table are screwed on the worm of the base body; therefore when the worm holder is driven to move upward or downward, the worktable will synchronously be moved up or down quickly. When the control rod is released and automatically recovers its original position by the elastic compressing units, the worktable will stop moving up and down.

### BACKGROUND OF THE INVENTION

1. Field of the Invention

This invention relates to a worktable-elevating device for the planing table of a planer, particularly to one able to move the worktable up and down with quickness.

2. Description of the Prior Art

A conventional planer usually has its worktable moved up and down by manually turning around a hand wheel, wasting labor and time and unable to quickly elevate a planing table. Another conventional planer is provided with an electrically elevating device to drive a planing table to move up and down, having complicated structure and increasing producing cost.

### SUMMARY OF THE INVENTION

The objective of this invention is to offer a worktable-elevating device for a planer, able to quickly move the worktable up and down by pulling a control rod and automatically actuate the worktable to atop moving by releasing the control rod.

### BRIEF DESCRIPTION OF DRAWINGS

This invention will be better understood by referring to the accompanying drawings, wherein:

FIG. 1 is a perspective view of a planer in the present invention:

FIG. 2 is a perspective view of the worktable-elevating device for a planer in the present invention:

FIG. 3 is an exploded perspective view of the worktable-elevating device for a planer in the present invention:

FIG. 4 is a side perspective view of the work table elevating device for a planer in the present invention:

FIG. 5 is a cross-sectional view of the worktable-elevating device for a planer in the present invention:

FIG. 6 is a front view of the worktable elevating device for a planer in the present invention:

FIG. 7 is a perspective view of the worktable-elevating device for a planer in the present invention showing a control rod pulled upward:

FIG. 8 is a front view of the worktable-elevating device for a planer in the present invention, showing the control rod pulled upward:

FIG. 9 is a perspective view of the worktable-elevating device for a planer in the present invention, showing the control rod pulled downward: and

FIG. 10 is a front view of the worktable-elevating device for the planing table of a planer in the present invention, showing the control, rod pulled downward.

### DETAILED DESCRIPTION OF THE PREFERRED EMBODIMENT

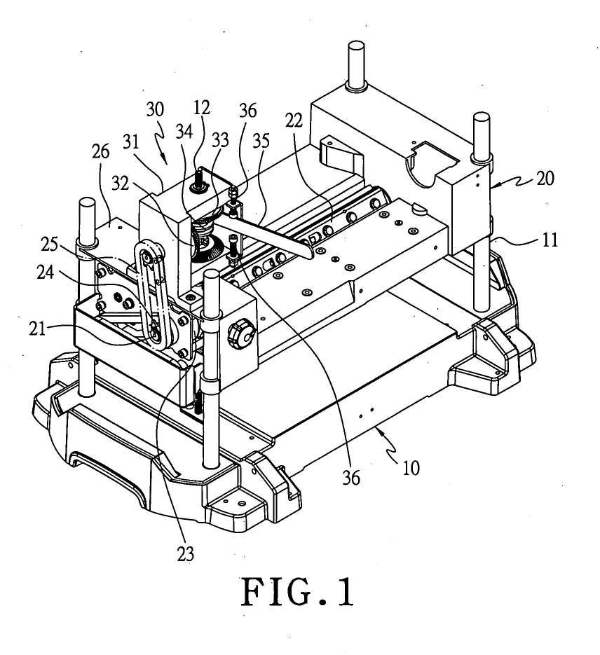

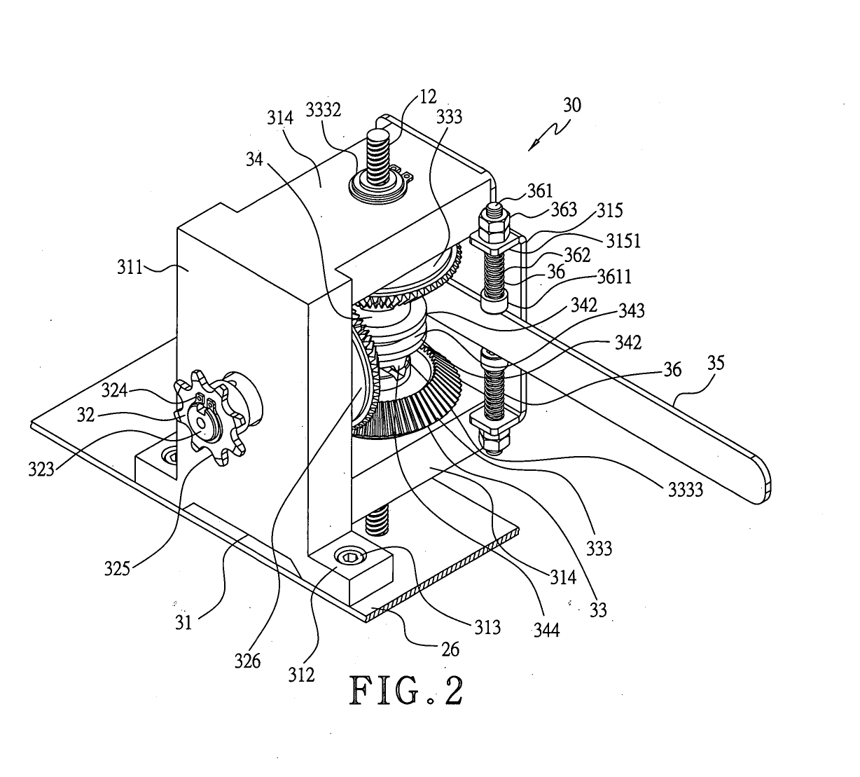

A preferred embodiment of a worktable elevating device for a planer in the present invention, as shown in FIGS. 1, 2 and 3, is combined with a bottom base 10, a planing table 20 of a planer.

The bottom base 10 has its four corners respectively fixed with a guide column 11 and has a worm 12 secured at a preset location on one side.

The worktable 20 is slidably fitted on the four guide columns 11 of the bottom base 10 and threadably assembled with the worm 12 of the bottom base 10, able to be moved up and down. The worktable 20 is provided with an actuating shaft 21 on a preset side, a knife shaft 22 for planing and a motor 23 for driving the actuating shaft 21 and the knife shaft 20. The actuating shaft 21 is provided with an actuating chain wheel 24 having an endless chain 25 engaged thereon.

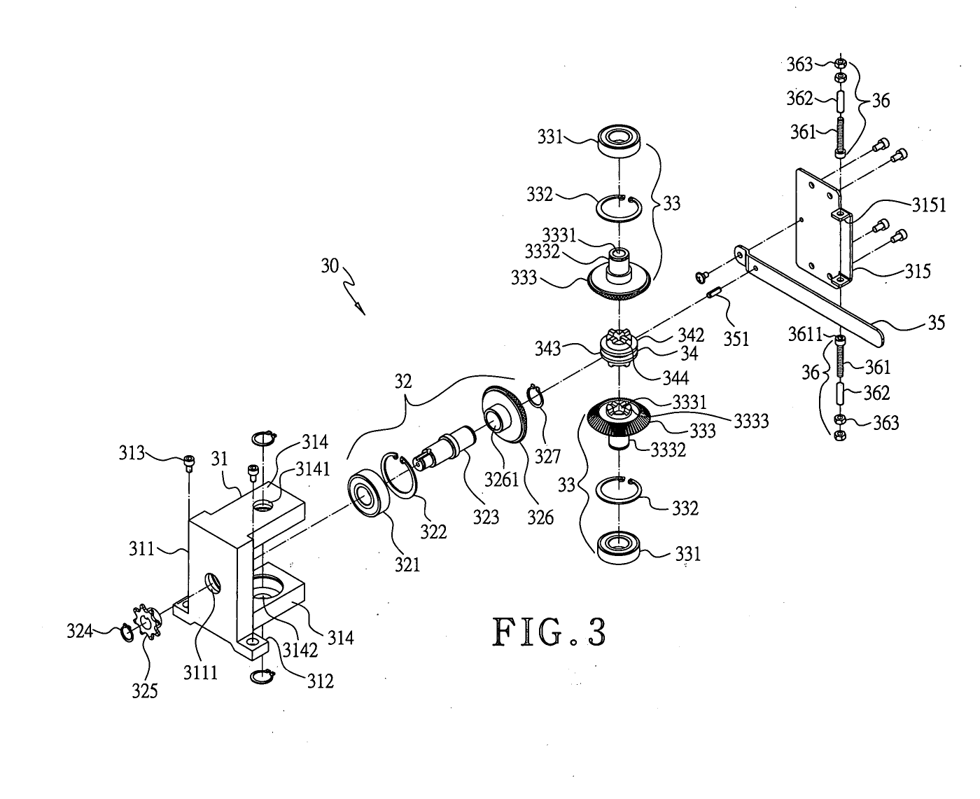

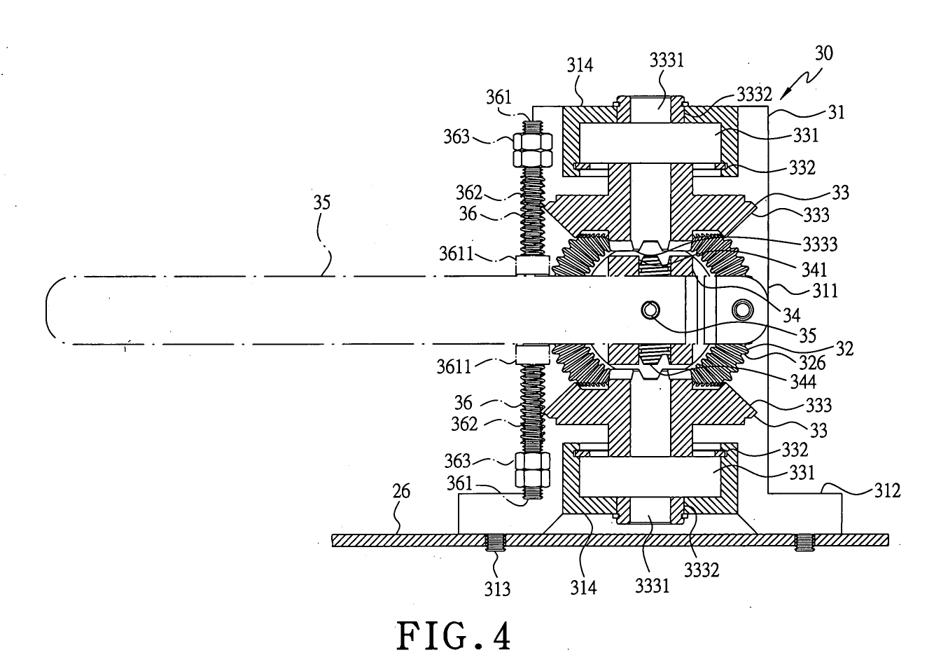

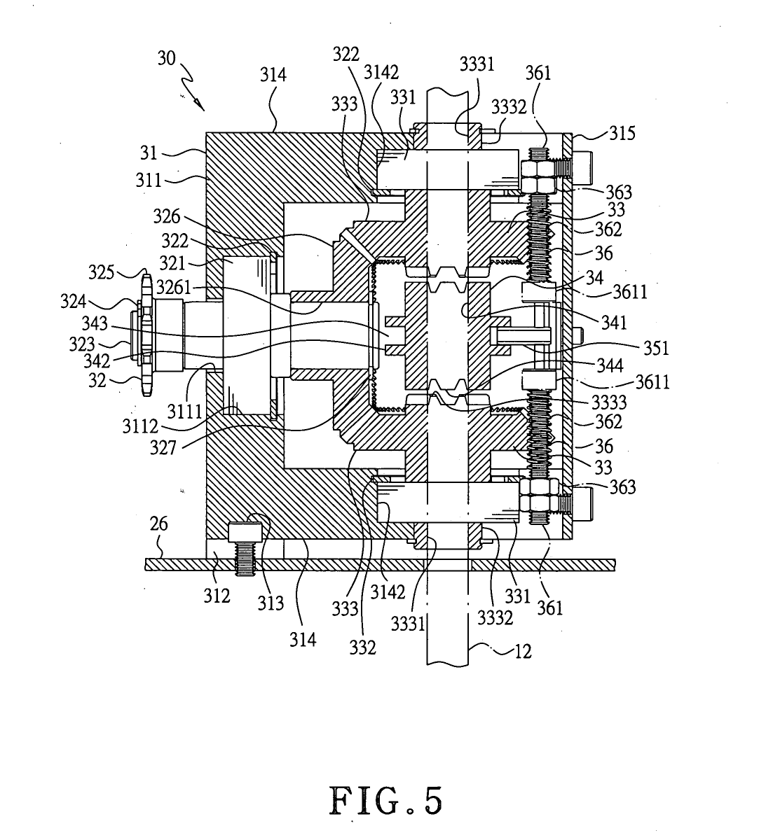

The worktable-elevating device 30, as shown in FIGS. 3, 4 and 5, includes a base body 31, an input gear unit 32, two output gear unit 33, a worm holder 34, a control rod 35 and two elastic compressing units 36. The base body 31 contains a vertical bearing holding plate 311 having two, pivotal lugs 312 respectively extending outward at its opposite lower sides to be fixed on the topside wall 26 of the worktable 20 by bolts 313. The vertical bearing holding plate 311 is provided in the center with a shaft hole 3111 having its inner side bored with a recessed bearing position groove 3112 with a comparatively large diameter. Besides, the vertical bearing holding plate 311 has its upper and lower end respectively extending outward to form a horizontal bearing holding plate 314. Each horizontal bearing holding plate 314 is bored in the center with a shaft hole 3141 having its inner side formed with a recessed bearing groove 3142 with a comparatively large diameter. A plate cover 315 to be fixed on the free end wall of the two horizontal bearing holding plates 314 has one side provided at a preset position with an upper and a lower pivotal member 3151 extending horizontally toward the base body 31.

The input gear unit 32 consists of a bearing 321, a transmission shaft 323 and a bevel gear 326. The bearing 321 is positioned in the bearing groove 3112 of the vertical bearing holding plate 311 of the base body 31 by a C-shaped lock washer 322. The transmission shaft-323 is pivotally inserted through the bearing 321 and has one end extending-out of the shaft hole 3111 of the vertical bearing holding plate 311 and having a driven chain wheel 325 fixed thereon by a C-shaped lock washer 324, with the drive chain wheel 325 driven to rotate together with the actuating chain wheel 24 of the worktable 20 by means of the endless chain 25, which meshes with the two chain wheels 24 and 325. The bevel gear 326 has its central shaft hole 3261 fitted with the transmission shaft 323 at the inner side of the base body 31 and secured thereon by a C-shaped lock washer 327, letting the bevel gear 326 actuated to rotate with the transmission shaft 323.

The two output gear units 33 are respectively assembled on the upper and the lower horizontal bearing holding plate 314 of the base body 31. Each output gear unit 33 is composed of a bearing 331 and a bevel gear 333. The bearing 331 is positioned in the bearing position groove 3142 of the horizontal bearing holding plate 314 by a C-shaped lock washer 332. The bevel gear 333 is bored with a central shaft hole 3331 to be fitted around the worm 12 of the bottom base 10, with a proper gap formed between the shaft hole 3331 and the worm 12. A shaft tube 3332 extends outward from one side of the shaft hole 3331 of the bevel gear 333 to be pivotally inserted through the bearing 331. In addition, the two bevel gears 333 of the two output gear units 33 and the bevel gear 326 of the input gear unit 32 respectively have their rotation axes inter crossing at 90 degrees so that they can be meshed with each other and driven to rotate reversely. Further, each bevel gear 333 of the two output gear units 33 has the other side, opposite to the shaft tube 3332, annularly provided with four projecting block-shaped engaging teeth 3333.

The worm holder 34 is screwed with the worm 12 between the two output gear units 33 and separated from the two bevel gears 333 at a proper distance. The worm holder 34 is bored with a center threaded hole 341 in the center to be screwed with the worm 12 and has its intermediate outer edge formed with two annular flanges 342 extending outward horizontally, with an annular position groove 343 formed between the two annular walls 342. Further, the worm holder 34 has its upper and lower side respectively provided with four projecting block-shaped engaging teeth 344 to mesh with the block-shaped engaging teeth 3333 of the two bevel gears 333 of the two output gear units 33.

The control rod 35 shaped as an elongate plate has one end pivotally assembled at an intermediate position of one side of the plate cover 315, opposite to the pivotal members 3151, and has a position stud 351 fixed at a preset position near its pivotal fulcrum to be inserted in the annular position groove 343 of the worm holder 34. Thus, when the control rod 35 is pulled upward or downward, the position stud 351 will actuate the worm holder 34 to move up or down to engage with one of the two output gear units 33.

The two elastic compressing units 36 respectively consists of a compressing bolt 361, a compression spring 362 and two locking nuts 363. The pressing bolt 361 is fitted around by the compressing spring 362 and vertically inserted through the pivotal member 3151 of the plate cover 315 to be fixedly positioned thereon by the two locking nuts 363. Thus, two heads 3611 of the two pressing bolts 361 can elastically compress a preset portion of the control rod 35 so as to enable the control rod 35 to automatically recover its original position by the elastic compressing unit 36 after the control rod 35 is pulled upward or downward and then released.

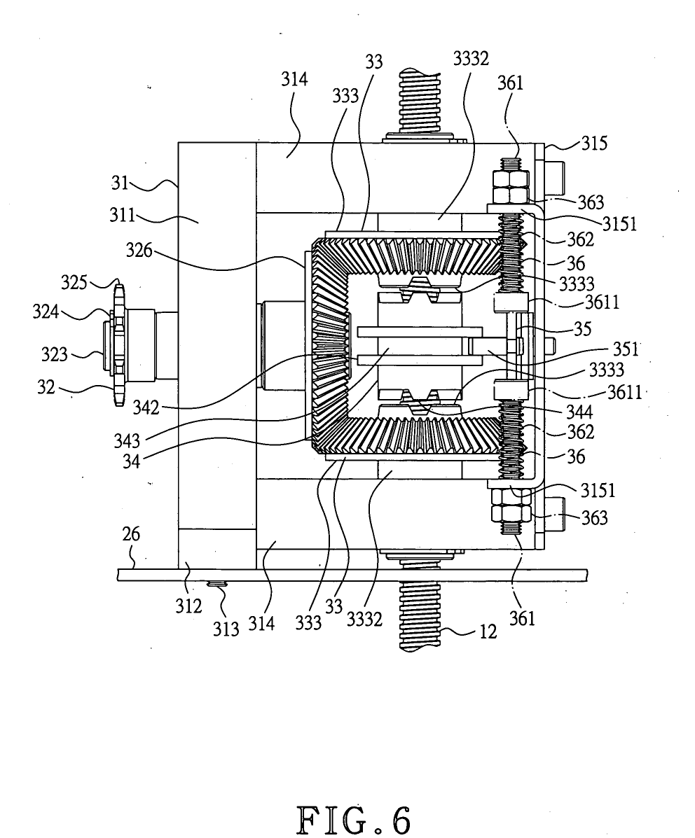

When the worktable elevating device 30 is in a motionless condition, as shown in FIG. 6, the force a applying end of the control rod 35 is compressed by the two elastic pressing units 36 and positioned horizontally, thus forming a certain gap between the engaging teeth 344 of the worm holder 34 and the engaging teeth 3333 of the two bevel gears 333 of the two output gear units 33, with the worm holder 34 not driven to rotate.

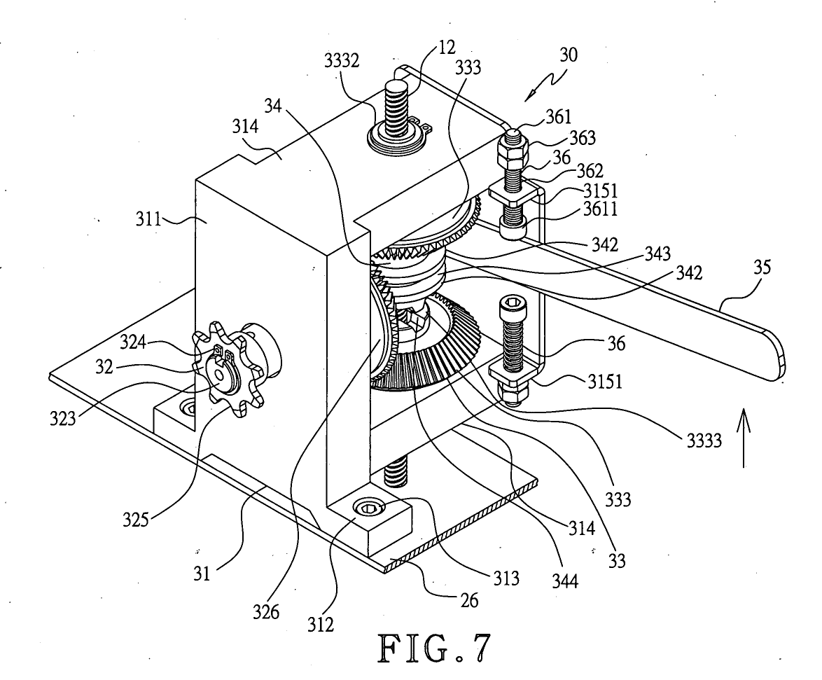

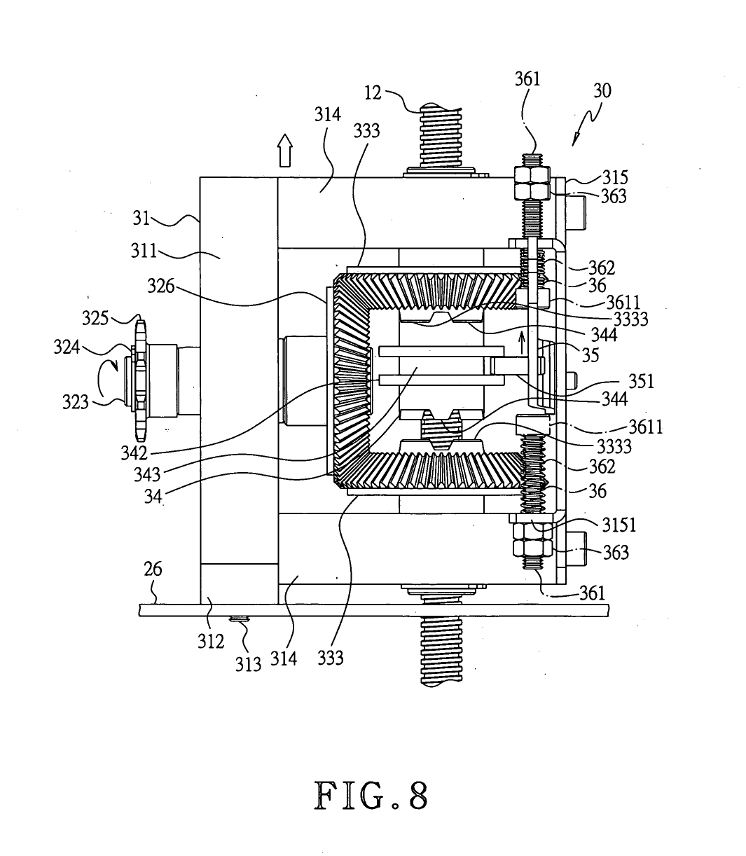

In operating and using, as shown in FIGS. 7 and 8, when pulled upward with its pivotal fulcrum serving as a rotating shaft, the control rod 35 will be turned upward and its position stud 35 inserted in the annular position groove 343 of the worm holder 34 will simultaneously move the worm holder 34 upward to let the engaging teeth 344 on the topside of the worm holder 34 meshing with the engaging teeth 3333 on the bottom side of the bevel gear 333 of the upper output gear unit 33. At this time, the upper output gear unit 33 will drive the worm holder 34 to rotate together in the same direction and move the worktable 20 upward quickly because of the worm holder 34 engaging with the worm 12. Additionally, when the force-applying end of the control rod 35 is pulled upward, it will push against the pressing bolt 361 of the upper elastic compressing unit 36 and compress the compression spring 362. Therefore when the worktable 20 is moved to a needed position and the control rod 35 is released, the force applying end of the control rod 35 will recover its originally horizontal position by the recovering resilience of the compression spring 362, and the worm holder 34 will disengage from the upper output gear unit 33 to let the worktable 20 a automatically stop moving up and down.

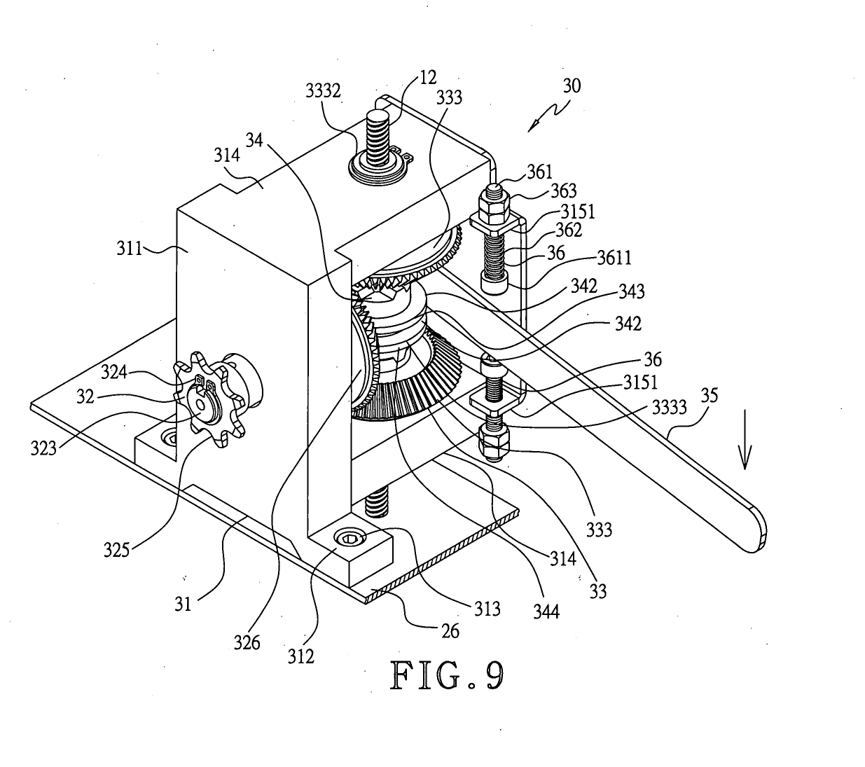

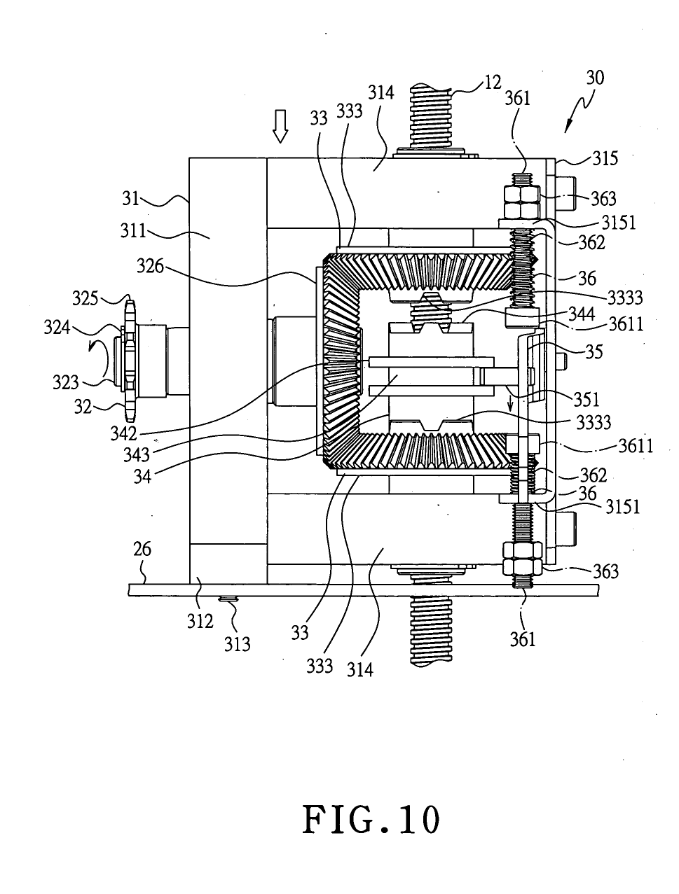

On the contrary, as shown in FIGS. 9 and 10, when the control rod 35 is pulled downward, the worm holder 34 will be moved downward and meshed with the lower output gear unit 33 to be actuated to rotate together with the lower output a gear unit 33 in the same direction and move the worktable 20 downward quickly. When the worktable 20 is adjusted to a needed position and the control rod 30 is released, the force-applying end of the control rod 30 will automatically recover its original position by the recovering resilience of the compression spring 362 and the worktable 20 will stop moving up and down.

Evidently, the worktable 20 can easily and quickly be moved up or down only by pulling the control rod 35 upward or downward and can be stopped moving up or down by releasing the control rod 35 to let it automatically recover its original position by the recovering resilience of the two elastic pressing units 36, easy in handling and practical worth and industrial profitability.

In addition, a backlash of a preset size between the worm holder 34 of the elevating device 30 and the worm 12 of the bottom base 10 can be set in advance, and the size of this backlash is approximately equivalent to the total of two engaging gaps formed between the worm holder 34 and the two output gear units 33. Thus, when the control rod 35 actuates the worm holder 34 to move upward or downward, the backlash or the engaging gap enables the worm holder 34 to be moved up and down, and when the backlash or the engaging gap is eliminated, the worm holder 34 can closely and smoothly be engaged with the worm 12 or the output gear unit 33.

While the preferred embodiment of the invention has been described above, it will be recognized and understood that various modifications may be made therein and the appended claims are intended to cover all such modifications that may fall within the spirit and scope of the invention.

1. A worktable-elevating device for a planer combined with:
A bottom base having its four corners respectively fixed with a guide column, said bottom base having a worm secured at a preset position on one side:
A worktable slidably fitted on said four guide columns, said worktable screwing with said worm of said bottom base, said worktable able to be moved up and down along said four guide columns, said worktable provided with an actuating shaft at one side, said actuating shaft fixed thereon with an actuating chain wheel, said actuating chain wheel meshing with an endless chain:
Said worktable elevating device comprising a base body, an input gear unit, two output gear units, a worm holder and a control rod:
Said base body fixedly assembled on one side of the top side of said planing table:
Said input gear unit assembled at a preset location of said base body, said input gear unit provided with a transmission shaft, said transmission shaft having one end fixed thereon with a driven chain wheel, said driven chain wheel driven to rotate together with said actuating chain wheel of said planing table by means of said endless chain:
Said two output gear units respectively assembled at preset positions of said base body, said two output gear units movably fitted around said worm of said bottom base, said two output gear in its respectively meshing with said input gear unit to rotate reversely:
Said worm holder screwing with said worm between said two output gear units, said worm holder respectively separated from said two output gear units by a preset distance:
Said control rod having an end pivotally assembled at a preset location of said base body beside said worm holder, said control rod having a portion near its pivotal fulcrum connected with said worm holder, said worm holder moved up or down to be meshed with one of said two output gear units and actuated to rotate when said control rod is pulled upward or downward, said worm holder disengaged from said output gear unit and stopping rotating when said control rod is released to recover its original position: and
Said control rod pulled upward or downward to let said worm holder meshed with one of said two output gear units, said worm holder driven to rotate along said worm and actuate said worktable to quickly move up and down.

2. The work table elevating device for a planer as claimed in claim 1, wherein said base body comprises a vertical bearing holding plate having two pivotal lugs respectively extending outward at its opposite lower sides to be fixedly assembled on the topside wall of said worktable by bolts, said vertical bearing holding plate provided with a shaft hole in the center, said shaft hole having its inner side bored with a recessed bearing groove with a comparatively large diameter, said vertical bearing holding plate having its upper and lower end respectively extending outward to form a horizontal bearing holding plate, said two horizontal bearing holding plates respectively bored with a shaft hole in the center, said shaft hole of each said horizontal bearing holding plate having its inner side bored with a recessed bearing groove with a comparatively large diameter, a plate cover fixed on the free end wall of said two horizontal bearing holding plates, said plate cover having one side provided at preset positions with an upper and a lower pivotal member, said two pivotal members extending outward horizontally toward said base body.

3. The worktable elevating device for a planer as claimed in claim 2, wherein said input gear unit comprises a bearing, a transmission shaft and a bevel gear, said bearing positioned in said bearing groove of said vertical bearing holding plate by a C-shaped lock washer, said transmission shaft pivotally inserted through said bearing, said transmission shaft having one end extending out of said shaft hole of said vertical bearing holding plate for fixing said drive chain wheel thereon, said bevel gear having its central shaft hole fitted around said transmission shaft at the inner side of said base body, said bevel gear fixed on said transmission shaft by a C-shaped lock washer to rotate together and meshing with one of said two output gear units.

4. The worktable elevating device for a planer as claimed in claim 2, wherein said two output gear units are respectively assembled on said two horizontal bearing holding plates and respectively comprise a bearing and a bevel gear, said bearing firmly positioned in said bearing groove of said horizontal bearing holding plate by a C-shaped lock washer, said bevel gear bored with a central shaft hole to be fitted around said worm, a preset gap formed between said central shaft hole of said bevel gear and said worm, a shaft tube extending from one side of said central shaft hole, said shaft tube pivotally inserted through said bearing, said bevel gears of said two output gear units respectively meshing with said bevel gear of said input gear unit and driven unit rotate, said bevel gear of each said output gear unit having one side, opposite to said shaft tube, annularly provided with plural projecting engaging teeth with a preset shape.

5. The work table elevating device for a planer as claimed in claim 3, wherein said bevel gear of said input gear unit meshes with said two bevel gears of said two output gear units.

6. The worktable elevating device for a planer as claimed in claim 2, wherein said worm holder is provided with a threaded hole in the center to screw with said worm and has its intermediate outer edge formed with two annular walls, having an annular position groove formed between said two annular walls, said worm holder having its upper and lower side respectively provided with plural engaging teeth preset in shape and protruding axially, said engaging teeth of said worm holder meshing with said engaging teeth of said output gear unit and driven to rotate.

7. The worktable elevating device for a planer as claimed in claim 4, wherein said engaging teeth provided on the upper and the lower side of said worm holder are respectively meshed with said engaging teeth on said bevel gear of said two output gear units and driven to rotate.

8. The worktable elevating device for a planer as claimed in claim 2, wherein said control rod is shaped as an elongate plate and has one end pivotally assembled on said plate cover of said base body and has a position stud fixed at a preset location near its pivotal fulcrum, said position stud inserted in said annular position groove of said worm holder, said position stud actuating said worm holder to move toward one of said two output gear units when said control rod is pulled upward or downward.

9. The worktable elevating device for the planer as claimed in claim 1, wherein said two elastic compressing units respectively comprise a pressing bolt, a compression spring and two locking nuts, said compressing bolt fitted thereon with said compression spring and vertically inserted through said pivotal member of said plate cover, said compressing bolt positioned on said pivotal member of said plate cover by said locking units, the heads of said two compressing bolts elastically pressing a preset portion of said control rod, said control rod able to automatically recover its original position by the resilience of said elastic compressing unit after said control rod is released.

10. The worktable elevating device for a planer as claimed in claim 1, wherein said actuating shaft and the knife shaft of said worktable are driven to operate by the same motor.

11. The worktable elevating device for a planer as claimed in claim 1, wherein a backlash of a present size between said worm holder and said worm is set in advance and the size of said backlash is approximately equivalent to the total of two engaging gaps formed between said worm holder and said two output gear units so as to enable said worm holder to move upward and downward and be engaged closely and smoothly with said two output gears.

12. The worktable elevating device for a planer as claimed in claim 4, wherein said bevel gear of said input gear unit meshes with said two bevel gears of said two output gear units.

13. The worktable elevating device for a planer as claimed in claim 6, wherein said engaging teeth provided on the upper and the lower side of said worm holder are respectively meshed with said engaging teeth on said bevel gear of said two output gear units and driven to rotate.

14. The worktable elevating device for a planer as claimed in claim 6, wherein said control rod is shaped as an elongate plate and has one end pivotally assembled on said plate cover of said base body and has a position stud fixed at a preset location near its pivotal fulcrum, said position stud inserted in said annular position groove of said worm holder, said position stud actuating said worm holder to move toward one of said two output gear units when said control rod is pulled upward or downward.

15. The worktable elevating device for the a planer as claimed in claim 2, wherein said two elastic compressing units respectively comprise a pressing bolt, a compression spring and two locking nuts, said compressing bolt fitted therein aid compression spring and vertically inserted through said pivotal member of said plate cover, said compressing bolt positioned on said pivotal member of said plate cover by said locking nuts, the heads of said two compressing bolts elastically pressing a preset portion of said control rod, said control rod able to automatically recover its original position by the resilience of said elastic compressing unit after said control rod is released.
